(19) United States
(12) Patent Application Publication
(10) Pub. No.: US 2008/0223358 A1
(43) Pub. Date: Sep. 18, 2008

(54) Apparatus with a Receptacle for Dough Pieces, for Example for Leavening the Latter

(76) Inventor: Wolfgang Birnbaum, Thungen (DE)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 12/089,941

(22) PCT Filed: Oct. 11, 2005
(86) PCT No.: PCT/EP2005/055155

§ 371 Date: Apr. 30, 2008

(51) Int. Cl. A21C 13/00

(52) U.S. Cl. 126/281

(57) ABSTRACT

Device for holding dough items, mainly for proofing, shaped as a basket with a base and a side wall made of plastic, with interlinked side ribs and at least in parts with ventilation slits, openings or other through holes.

The invention relates to a device with a holding form for dough items, mainly for proofing.

Generic devices are known as for example plastic proofing baskets (DE-U-92 10 256.5) and plastic bread moulds (DE-U-84 05 177.9), respectively.

The generic references reflect a considerable demand for creating a dough holding device, which is optimized from a hygienic viewpoint. For remedy, reference is made to the device stated under claim 1, according to which it is suggested to have the bottom part as well as the side walls of the form made of plastic. This is intended to result in an advantageous optimization from a hygienic viewpoint.

Plastic proofing baskets are known from the previously known company brochure “RINGOPLAST—Kunststoffartikel für Bäcker und Konditoren¹” or the reference DE-U-92 10 256.5 mentioned at the beginning. These proofing baskets have side walls with horizontal air slits in order to prevent the dough from sticking to the inside of the basket. The inside furthermore has a rough surface to allow for good adhesion of the flouring. The fact that the air slits are horizontal has the disadvantage that the outgoing air containing the humidity can not be transported effectively out of the inside of the basket and the dough, respectively. As a remedy, the following optional invention version is suggested: the side ribs on the outside of the basket are bent and/or curved in the area of the through holes delimited by them, so that an outside tangent positioned next to the curve or bend of a side rib is sloped in such a way that it encloses an angle larger than zero with the level of the (basket) base. This angle can range from for example 5° to 85°. Ventilation ducts tilting diagonally upwards compared to the base level can be created with this version. With the outside of the side ribs designed in such a way, positions favorable for thermal and humidity can be achieved. The humidity created in the proofing process of for example a piece of bread dough plus the inherent heat can exhaust much more easily and more effectively from the holding or device form according to the invention. Thus accumulation of humidity within the dough holding form and the tendency of the dough item to stick to the inside of the proofing basket are reduced. Translator's note: Plastic articles for bakers and convectioners

As there are gaps between the side ribs of the device form according to the invention, due to the air slits, the side ribs must be sufficiently stabilized. This requirement is fulfilled with a special version of the invention: the side ribs are interlinked by means of bridges, preferably running to the base.

In connection with the aforementioned bridges, this opens up the possibility for another optional, advantageous version: providing for stacking devices in the upper part of the bridges, thus allowing the baskets to be space-savingly stacked on top of for example other baskets or other items. This reduces the cost for warehousing of the baskets according to the invention.

To facilitate taking the dough items out of the basket, the insides of the side ribs—as an optional version—are, if applicable, bent and/or tilted in comparison with the base level in such a way that a tangent positioned on the inside encloses an angle with a base-level normal running diagonally or perpendicularly to the base that is decreasing from the region of the basket base towards the upper edge of the basket and to the rim of the opening, respectively. That way the opening width of the side ribs is still enlarged toward the upper intake opening, though in the lower base area there already is a disproportionately high bulging or widening of the diameter or the inner width, caused by the inner walls increasingly leaning out. That way a rounded transition between base and side walls can be achieved and edges can be avoided, which facilitates taking the dough item out of the basket.

To further benefit the proofing of the dough items and to further facilitate taking them out of the basket, an optional version of the invention intends the base of the basket to be made up of base ribs, for example in a plait pattern or a parallel structure, between which there are—at least partially—through holes as air slits or the like. This counteracts a vacuum behavior, which is a natural tendency of the dough item proofing inside the proofing basket. The base ribs should be interlinked with base bridges, as there are gaps between the base ribs in sections, cause by the air slits or other through-holes. These bridges could have the form of a six-pointed star or any other star and protrude from the bottom side of the side ribs to the outside or downwards, forming one or several legs. One leg of the basket could for example be formed as a ring. Within the framework of the invention, however, it could be advantageous to have through-holes in this leg as well, so as to allow for ventilation of the dough items from the base, also if the basket is standing on smooth surfaces.

The texture of the basket inside structure should be particularly rough, so that flour as separator for the dough items can stick to the inside to the form as well as possible. This is being provided for by the version of the invention with the inside(s) of one, several, or all side or base ribs of the basket having grooves, creases or other dents and/or ridges, which run parallel to the base level and/or an intake-opening level in case of the side walls. The grooves or creases can form a saber-toothed-like profile on the inside of the side walls, with the flour being able to settle on horizontally or diagonally upwards, or horizontal or base-parallel surfaces of the saber-toothed profile. As an alternative, flour can also deposit on the cascaded surface profile.

As an alternative or in addition to the grooves or creases or any other dents, retaining bases or other retaining ridges can be formed on the inside of one, several, or all side ribs. These can preferably form a ring on the inside, or be placed in places or sections as a row with discreet individual bases in the circumferential direction. Here, a functional, basically triangular-shaped cross section is formed functionally with the surface bordering on the side rib. Another advantage of the flour retaining bases on the inside of the side walls is—besides the fact that flour can deposit there—that flour contours form on the dough item, for example a piece of bread dough, so that taking the dough item out of the basket can be further improved still. The last point of view can be increased with another version of the invention: a leg, which is directed towards the inside of the basket, of the triangular-shaped cross section of the retaining base towards the base normal is tilted outward to the bordering side wall. That way a ramp running diagonally upward and out is achieved, which facilitates taking the dough item out of the proofing basket.

According to another optional version, the basket is made of a foamed and/or porous plastic or plastic compound of several materials and/or material components. Additives such as for example wood, cellulose, and/or horn chippings can be added. Using foamed and/or porous plastic has the effect of an increased heat insulation and improved humidity-tailback behavior of the basket toward the dough item. This entails lower condensation on the inside of the basket, and thus the tendency to stick is reduced. Another advantage of using foamed and/or porous plastic is the stronger reflection of heat back to the dough item. This has the effect of a more steady proofing process. Polypropylene for example is a practicable plastics material, which is helpful for a production by means of injection molding. As an alternative to that, polyurethane foam is also practicable.

In order to support a steady proofing process of the dough item in the basket, plastic with a bright and thus temperature-reflecting color is used in order to attain the optimum invention version. The thus achievable advantage comes into its own during retarding. Another advantage is the improved detection of dirt, which again helps to better fulfill the high hygiene requirements. With the brightly-colored, heat-reflecting plastic a further advantage can be achieved: the tendency of condensation at the inner side walls is diminished, because with the reflecting heat radiation, humidity is reflected back into the inside of the basket to the dough item. Colors such as bright blue, light ivory according to RAL 1015 and/or white-green according to for example RAL 6019 have proven to be practicable color samples.

The forming holding device for dough items in compliance with the invention should allow for fastening to basket holdings of industrial processors of dough items. For that purpose, base bridge- or base rim extensions in combination with screws or other fastening devices are exterior means of fastening.

In compliance with an advantageous version of the invention, holding and/or fastening devices are provided for in or at the basket base, which could be realized with a plug-in hole and/or a guidance groove for for example insertion through the basket holding. It is practicable if the guidance groove has a cross-sectional profile in the form of a dove tail. Attaching the holding and/or fastening devices at the outside or the bottom of the basket base seems to be practicable.

Holding devices complementary to the aforementioned holding and/or fastening devices can be positioned on the basket holdings. In the case of the plug-in holes or dovetail grooves, clips or snap-fits or any other latching devices that can be easily and cost-effectively produced as separate component parts without special tools are particularly suitable to fasten or adjust the device or basket according to the invention. Said holding systems are also suitable for quick take-up on conveyor belts for the purposes of cleaning or automatic dough item filling systems, for example. Said fastening system facilitates the use of the device according to the invention in automated washing systems.

The aforementioned dove-tail cross-sectional profile has the advantage that mainly in combination with clip-adjustments there is no necessity to fasten or unfasten screws when attaching the basket holding. That way the disadvantage of well-known fastening systems—that the screw-heads often leave imprints on the dough items—, is avoided.

It is in the nature of the invention that the basket should consist of several parts, and can consist of several compound parts and separately manufactured component parts, respectively. The individual parts can be permanently interlinked by means of tongue and groove joints or the like. Locking and snap-fit mechanisms or clips can help to fasten or adjust the parts. At the same time the linkages can be detached again, by for example unfastening or moving feather clips of hooks.

It is known from the publication DE-U-84 05 177 mentioned at the beginning that a previously round bread proofing basket can be converted into an oval-elongated bread proofing basket by inserting an intermediate individual piece. Then, however, the round or oval-elongated bread basket can not be broadened as well. This can be remedied with a special version of the invention: an intermediate individual piece is inserted between the longer, opposing wide sides of the holding form, and thus reaches from one of the shorter narrow sides to the other one, and that way over the entire length of the basket.

Further details, characteristics, combinations of characteristics, and effects on the basis of the invention result from the following description of preferred invention version samples as well as from drawings. These show with a schematic diagram each in:

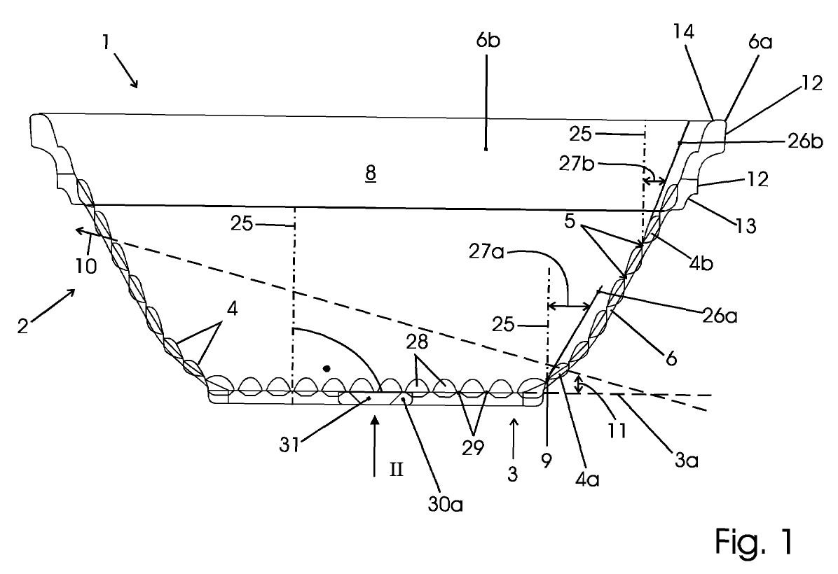

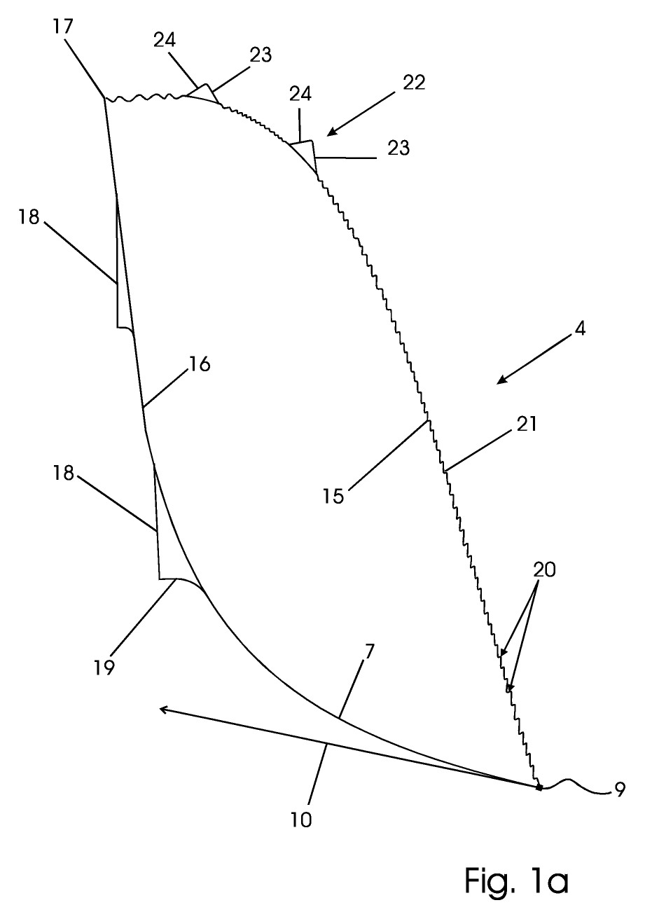

FIG. 1 a view cut through the base of a basket of the device according to the invention,

FIG. 1a a scaled-up detail from FIG. 1 to clarify the cross section of a side rib,

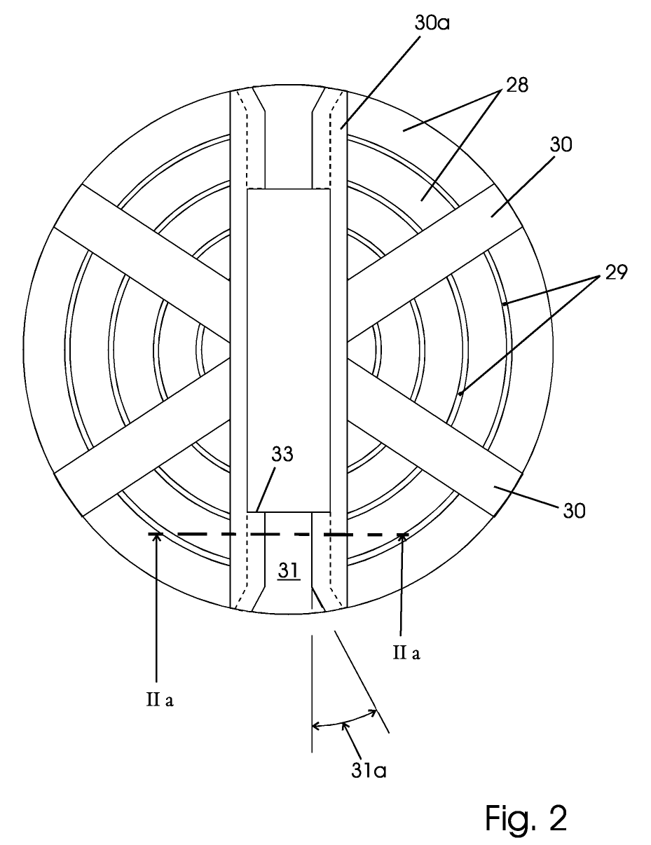

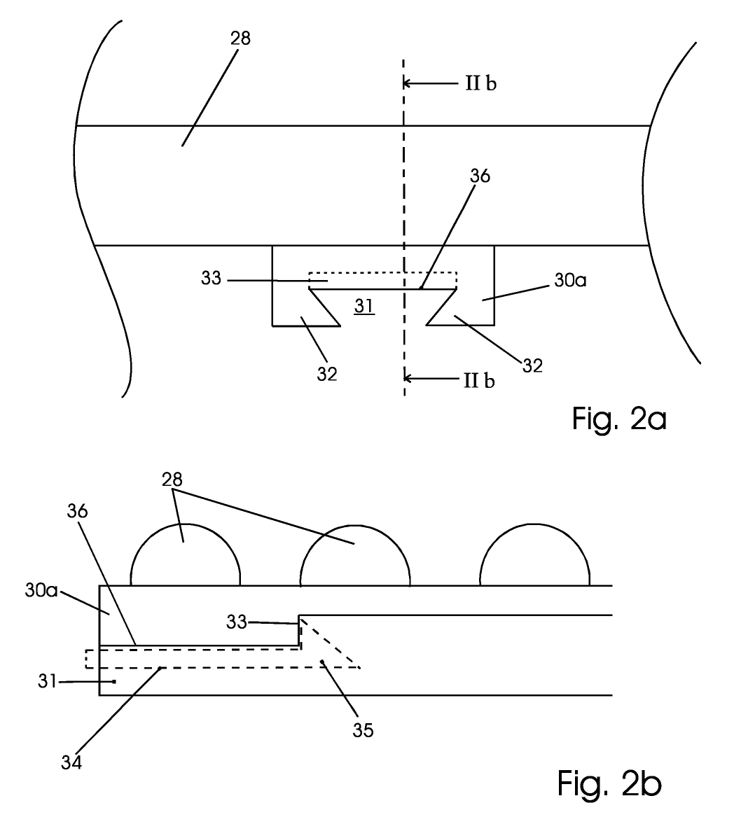

FIG. 2 a bottom view according to direction II in FIG. 1,

FIG. 2a a sectional view in compliance with line IIa-IIa in FIG. 2,

FIG. 2b a sectional view in compliance with line IIb-IIb in FIG. 2a,

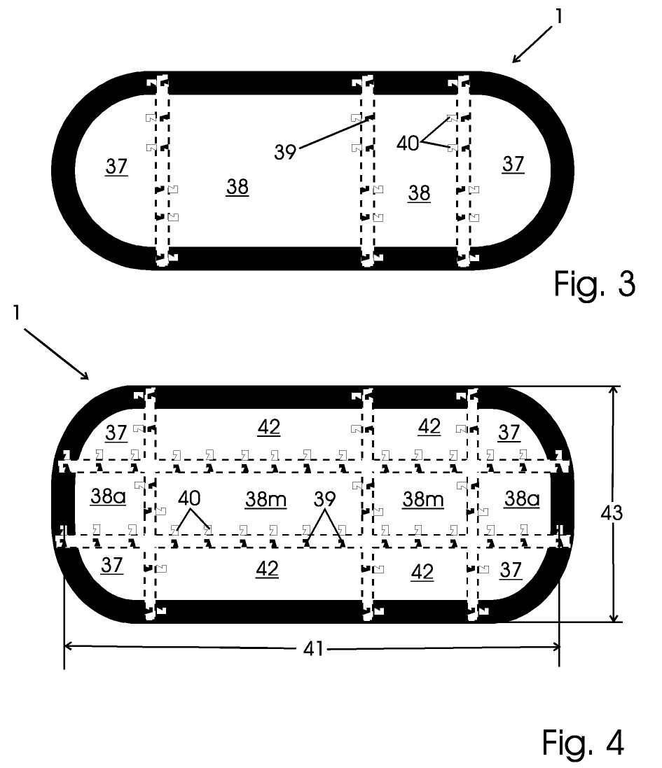

FIGS. 3 and 4 each a top view, providing the possibility to change length and width of the basket.

According to FIG. 1, the dough item holding device according to the invention is a cup-like basket 1, which is open at the top, with a side wall 2 and a base 3. The side wall 2 consists of a number of interlinked side ribs 4, which are graded downwards, and between which there are ventilation slits 5. The side ribs are linked by means of bridges 6 running down to the base 3. For stabilization purposes, a circumferential bridge 6b runs around the edge of the opening leading to the inside of the basket 1 in circumferential direction.

As can be seen on figure la, each of the side ribs 4 has a bend or curve section 7 on the half that is closer to the base 3. These bend or curve sections, which are convex to the outside environment, end in tips 9 pointing towards the inside of the basket 8 or to the base 3. An outside tangent 10 coming from this tip at the curve section 7 marks a ventilation duct for warm, humidity-containing air from the inside of the basket 8, directed diagonally upward. As can be easily seen from FIG. 1, the (extended) outside tangent 10 forms an angle 11 with a level 3a falling into the base 3, which is larger than zero. A useable, exemplary area for this tangent angle 11 could be between 5° and 15°, but also outside this are.

In compliance with FIG. 1, the bridges 6 in the region of the opening edge of the basket 1 all have the function of a stacking nose 12. This is achieved through a grooving 13 and a concave dent, respectively, on the outside of the bridge 6 in said edge region. It is particularly advantageous if the grooving 13 or the intake area around it is formed complementary to a convex curvature 14 at the loose end of the bridge 6 in the area of the opening edge, so that if several baskets 1 are stacked, the convex curvature 14 can be neatly put and adjusted in the holding area of the groove 13. That way the stack nose 12 of a bread proofing basket can be placed on the loose bridge end 6a of a congeneric basket 1, with sufficient air and distance, respectively, remaining for the upper basket for desiccation during storage, thanks to the distance between the stack nose 12 and the loose bridge end 6a. That way the stack noses create a space between the stacked baskets, in order to allow for improved desiccation of the baskets.

In compliance with figure la, the cross-sectional profile of an individual side rib 4 consists of an inside bend 15 and an outside bend 16, whose concave curvatures face each other and meet in the aforementioned tip 9 as well as in a second or upper tip 17. The outside bend 16 also includes the aforementioned curvature section 7. On the outside or the outside curve 16 of the side rib 4 there are protruding handle noses 18, each with a contact area 19, which runs roughly in parallel to the base. The handle noses 18 can also be similarly formed on the outsides of the downward-running bridges 6. On the inside or inside curve 15 of the side rib 4 the surface is rough because of a saber-toothed profile 20, which forms flour depositing surfaces 21 facing the opening of the basket. As an alternative, the surface can also have a cascaded profile. The flour retaining bases 22, which are formed with two legs of a triangle 23, 24, and are positioned closer to the upper tip 17 on the inside 15 of the side rib 4 also serve to retain flour. It is practicable to manufacture the flour retaining bases 22 with the (remaining) side rib 4 as one single piece, for example with the plastics injection molding method. Compared to the base normal 25 (see FIG. 1), the inner or lower leg of the triangle 23 is tilted outside with a bevel angle in order to facilitate or not hinder taking the dough item out of the proofing basket. It is practicable if the flour retaining bases 22 continuously run round the base normal 25, but they can also be individual bases separated from each other, in circumferential direction. If the gaps are not too large, the flour is still sufficiently prevented from slipping down the inside of the side wall.

In compliance with FIG. 1, a lower inside tangent 26a, which runs from the tip 9 to a side rib 4a closest to the base 3 and is positioned at its inside bend 15 there, forms the first or lower draft angle 27a with the base normal 25. This is wider than an analogously formed upper draft angle 27b, which is formed between an upper inside tangent 26b, positioned next to the inside bend 15 of a side rib 4b closer to the opening edge, and the base normal 25. A practicable value for the lower draft angle 27a could be for example 23°, for the upper draft angle 27b it could be 17°.

According to FIG. 1 in combination with the bottom view of FIG. 2, the base 3 also has a lamellae structure, consisting of numerous annulus-formed and concentric base ribs 28, between which there are gaps to form for example circular base ventilation slits 29. Several bridges 30, 30a, which are connected to the respective bottom side of the base ribs 28, give the base stability.

The bottom view of FIG. 2 in combination with the sectional views according to FIG. 2a, 2b shows the fastening system of the device according to the invention, which is used for fastening on for example basket carriers used in the baking industry. For that purpose, one 30a of the bridges 30, 30a is reinforced or rather wider compared to the others. Lengthwise, the wider bridge 30a is crossed by a guidance groove 31 with a cross-sectional dove-tail profile, which widens up at the entrance over wedge angle 31a to form a centering slip opening. The two opposing, wedge-shaped inner flanks 32 of the dove-tail guidance groove 31 end at a grading 33, which can be engaged from behind by a springy clip or snap-fit 34. The latter can be part of said basket carrier. The snap-fit 34 will be inserted into the guidance groove 31, with the end of the hook 35 being first pressed down from the groove base 36, so that it can then spring upwards when the final grading 33 is reached, and the latter can engage behind for fastening purposes. In order to manually undo this snapping or fastening device, a (not identified) notch at the side wall of the bridge 30a can be provided for.

In case of multiple-part versions of the holding basket 1 in compliance with FIG. 3, the principle of springy clip or snap-fit fastenings is also used in order to form a detachable connection of individual pieces 37 and intermediate individual pieces 38. For that purpose, springy latching noses 39 are formed on the outside of the individual pieces 37, 38. On opposite sides of neighboring (intermediate) individual pieces 37, 38, there are latching holes 40 as complementary-formed counterparts to those latching noses. That way the individual pieces 38 can be clicked together and snapped into place with the respective (outer) curved (end) individual piece in order to extend the basket. For undoing, (not identified) notches can be provided in order to manually set back latching noses 39 in the complementary latching hole 40, until an engaging from behind of a grading of the latching hole 40 through the latching nose 39 is removed.

In compliance with FIG. 4, an originally circular basket according to the invention, made of four round-shaped individual pieces 37 can not only be extended into one direction, but also (at the same time) be broadened. The four individual pieces 37 alone, which are—according to FIG. 4—round- or circular-shaped on the outer edge, can be assembled to form a roughly circular form already. However, it is the purpose of the version example according to FIG. 4, to be able to extend the basket into two different, orthogonal directions. This can be achieved by the longer long sides 41 on the respective end being assembled of the outer rounded individual pieces 37 on the one hand, and in between of two individual edge pieces 42 on the other hand. In line with FIG. 3 (see the intermediate individual pieces 38 there), the individual edge pieces 42 are of different lengths as well. The shorter narrow sides 43 can be broadened with two intermediate individual pieces 38a, each positioned on the outside, between two individual pieces 37 rounded on the outside. In order to form the base of the basket 1, the two outer intermediate individual pieces 38a are linked via two added and lined-up middle individual pieces 38m into one overall row. It is within the framework of the invention to make all intermediate individual pieces 38a, 38m or edge individual pieces 42 as one single intermediate or edge individual piece each, and to use it for broadening.

### List of Reference Numerals

1 Basket
2 Side wall
3 Base
3a Base level
4, 4a, 4b Side rib
5 Ventilation slits and through holes, respectively
6 Bridges
6a Free end of a bridge
6b Circumferential bridge
7 Curve section
8 Inside of the basket
9 Lower tip of side rib 4
10 Outside tangent
11 Tangent angle
12 Stacking nose
13 Groove
14 Convex curvature
15 Inside bend
16 Outside bend
17 Tip
18 Handle noses
19 Contact area
20 Saber-toothed profile
21 Flour depositing surface
22 Flour retaining base
23 Triangle leg
24 Triangle leg
25 Base normal
26a Lower inside tangent
26b Upper inside tangent
27a Lower draft angle
27b Upper draft angle
28 Base rib
29 Base ventilation slits
30, 30a Bridge
31 Guidance groove
31a Wedge angle
32 Inner flanks
33 Grading
34 Clips or snap-fits
35 End of hook
36 Groove base
37 Individual piece
38, 38a, 38m Intermediate individual piece
39 Snapping device
40 Latching drilling
41 Long sides
42 Individual edge pieces
43 Narrow sides

1. Device for holding dough items, mainly for proofing, shaped as a basket (1) with a base (3) and a side wall (2) made of plastic, with interlinked side ribs (4, 4a) and at least in parts with ventilation slits, openings or other through holes (5).

2. Device in compliance with claim 1, characterized in that the side ribs (4, 4a) delimit the through holes and on the outside of the basket (1) in the area of the through holes (5) are curved or bent in such a way, that an extension of an outside tangent (10) positioned next to the curve or bend of a side rib (4,4a) encloses a tangent angle (11) larger than zero with the plane of the base.

3. Device in compliance with claim 2, characterized in that the outside tangent (10) encloses an acute tangent angle (11), tilted outward, with the base plane (3a), which is wider than 5° and narrower than 85°.

4. Device in compliance with claim 2, characterized in that the side ribs (4, 4a) are interlinked by means of bridges (6), running to the base (3).

5. Device in compliance with claim 2, characterized in that in the upper part of the bridges (6) or in the area of the upper edge or opening of the basket (1), at least one stacking device is formed at the side wall (2) allowing the basket (1) to be space-savingly stacked on top of other baskets.

6. Device in compliance with claim 5, characterized in that the stacking device is formed as noses (12) or ledge or grooving (13) on the outside of the basket (1).

7. Device in compliance with claim 2, characterized in that the insides of the side ribs (4, 4a, 4b) are bent (15) or curved or sloped, so that an inside tangent (26a, 26b) positioned next to the inside encloses a draft angle (27a, 27b) with a base normal (25) running diagonally or vertically to the base (3) that is wider at the side ribs (4a) closer to the basket base (3) than at the side ribs (4b) closer to an upper edge of the basket or an upper opening edge.

8. Device in compliance with claim 7, characterized in that the draft angle (27a, 27b) of the inside tangent (26a, 26b) with the base normal (25) at the side ribs (4a) closer to the basket base (3) is between 20° and 26° and at the side ribs (4b) closer to the upper edge of the basket is between 14° and 20°.

9. Device in compliance with claim 2, characterized in that the base (3) of the basket (1) consists of base ribs (28) with—at least in part—through holes in between.

10. Device in compliance with claim 9, characterized in that the base ribs (28) on the basket base (3) are interlinked with bridges (30, 30a) protruding from the bottom side of the side rib (30, 30a) to the outside or downwards, forming one or several legs.

11. Device in compliance with claim 9, characterized in that at the outside or bottom side of the basket base (3) there is a protruding base ring with through holes or base ventilation slits (29) for outgoing air from the basket (1).

12. Device in compliance with claim 9, characterized in that there are protruding support bars on the outside or bottom side of the base.

13. Device in compliance with claim 9, characterized in that the base ribs (28) are completely or partially equipped with grooves, creases or dents.

14. Device in compliance with claim 9, characterized in that on the inside of one, several, or all side ribs or base ribs (4, 4a, 4b, 28) there are retaining bases, cascaded or saber-tootheded surface profiles, or other retaining elevations (22) or grooves, creases or dents protruding into the inside of the basket.

15. Device in compliance with claim 14, characterized in that the elevations (22) have a triangular cross section.

16. Device in compliance with claim 15, characterized in that a leg (23) of the triangular section bordering to the inside (8) of the basket (1) is tilted outward compared to the base normal (25).

17. Device in compliance with claim 14, characterized in that on each side rib there are several elevations (22) in the upper half of the side rib.

18. Device in compliance with claim 14, characterized in that the basket (1) is made of a foamed and/or porous plastic or plastic compound of several materials and/or material components.

19. Device in compliance with claim 18, characterized in that additives such as for example wood, cellulose, and/or horn chippings are added to the plastic or plastic compound.

20. Device in compliance with claim 18, characterized in that the plastic is foamed polypropylene or foamed polyurethane.

21. Device in compliance with claim 18, characterized in that the basket (1) is made of brightly-colored plastic with temperature-reflecting color.

22. Device in compliance with claim 2, with holding or fastening devices in or on the base (3), characterized in that the holding or fastening devices have a plug-in hole or a guidance groove (31) with a dove-tail cross-sectional profile, and that the plug-in hole or the guidance groove (31) is on the outside or the bottom side of the base (3).

23. Device in compliance with claim 22, characterized in that the dove-tail guidance groove (31) is integrated in a fastening strip or a bridge (30a), which is locked into position on the bottom side or outside of the base.

24. Device in compliance with claim 22, characterized in that the guidance groove (31) has a grading (33) for the purposes of engaging from behind by means of a clip or snap-fit (34) of a third item on its groove base side (36), which is opposite its longitudinal opening.

25. Device in compliance with claim 2, with the basket (1) being elongated with two longer long sides and two shorter narrow sides (41, 43), consisting of a number of separately manufactured individual pieces (37, 38, 42), which can be interlinked; and in relation to each other the individual pieces (37, 38, 42) are graded or have measurements coordinated with each other, so that the length, width, or diameter of the basket (1) can be made larger or smaller, depending on whether at least one individual piece (37, 38, 42) is added or omitted, characterized in that there is at least one intermediate individual piece (38a, 38m), which runs from one narrow side (43) to the other between the long sides (41) over the entire length of the basket (1).

26. Device in compliance with claim 25, characterized in that two or more intermediate individual pieces (38a, 38m) positioned between the long sides (41), can be lined up next to each other, so that they stretch over the entire length of the basket (1) from one narrow side (43) to the other.

27. Device in compliance with claim 25, characterized in that the two opposing long sides of the basket (1) each are realized by means of several different individual edge pieces (42).

28. Device in compliance with claim 25, characterized in that the connection of two individual pieces (37, 38, 42) is detachable, lockable or fixable by means of a manually operable locking device (39, 40).
